(19) United States
(12) Patent Application Publication
(10) Pub. No.: US 2008/0201595 A1
(43) Pub. Date: Aug. 21, 2008

(54) INTELLIGENT POWER CONTROL

(75) Inventor: Charlie Kawasaki, Portland, OR (US)

Correspondence Address: PERKINS COIE LLP;PATENT-SEA, P.O. BOX 1247, SEATTLE, WA, 98111-1247, US

(73) Assignee: Pacific Star Communications, Inc., Portland, OR (US)

(21) Appl. No.: 12/013,240

(22) Filed: Jan. 11, 2008

Related U.S. Application Data
(60) Provisional application No. 60/880,154, filed on Jan. 11, 2007.

(51) Int. Cl. G06F 1/26; G06F 11/30

(52) U.S. Cl. 713/330; 713/340

(57) ABSTRACT

An intelligent power control system for intelligently controlling startup and shutdown sequences of IT equipment to reduce peak power requirements is provided. The intelligent power control system sends an indication to power up to a power module connected to an electronic device. The system monitors the power consumption of the electronic device during startup, and determines when the electronic device has reached a peak level of power consumption. The system then powers up other devices based on the power consumption characteristics of each preceding device. The system may use similar techniques when shutting down devices or transitioning devices from a low-power state to a normal power state. Thus, the intelligent power control system establishes an order and timing for powering up or down electronic devices that improves the power consumption characteristics of the electronic devices and reduces the power requirements of the electronic devices allowing smaller, lighter, and less expensive power supplies and battery backup systems to be used.

### CROSS-REFERENCE TO RELATED APPLICATIONS

The present application claims the benefit of U.S. Provisional Patent Application No. 60/880,154 (Attorney Docket No. 56934-8009.US00) entitled “INTELLIGENT POWER CONTROL,” and filed on Jan. 11, 2007, which is hereby incorporated by reference.

### BACKGROUND

It is fairly well understood in the information technology (IT) and communications industries that starting up a system of IT equipment requires considerably more electrical power than the power required to run the system at steady state. This is because of a variety of factors including the extra power required to spin-up hard drives and fans, the tremendous computational load of starting applications and operating systems, and so forth. In networking/communications equipment, initializing network services, establishing connections such as VPNs, and so on all require significant startup power. This startup power draw can temporarily double the power requirements of the system versus the steady state power requirements. Thus, the power consumption of typical IT equipment has a startup power “hump” as shown in FIG. 1. Manufacturers and IT professionals generally plan for a peak power load anywhere from 40% to 80% greater than the operational steady-state power load by ensuring that the power supply or supplies in the system are large enough to handle the expected peak load.

It is also becoming fairly well understood in the IT industry that after the startup sequence, various types of IT and communications equipment is able to save substantial power by entering into “power-saving” modes, such as while under light loads. Today's servers and networking equipment reduce voltage to processors, spin-down hard drives, turn off networking equipment, and so forth while under light load. Thus, the corollary to the peak power draw at startup is the shutdown sequence, where servers and networking equipment undergo significant heavy computation activity to perform actions such as writing and closing log files, saving application state, deleting temporary files, and so on. In order to perform this work, not only does the equipment have to spin up hard drives, but modern equipment must transition from “power saving” state to a fully active state.

Further exacerbating the problem, as IT and communications equipment transitions from low-power to full-power modes, the heat dissipated by processors requires cooling fans to spin up. This adds considerably to the power-draw requirements during peak usage, such as at startup and shutdown. FIG. 2 is a graph showing power draw of fans relative to fan speed. In many types of equipment, as equipment heats up because of load, the equipment increases fan speed. In some equipment, where fans are completely stopped in low-load conditions, restarting those fans requires more current than during normal operation of the fans. Thus, the power-draw profile for fans may look like FIG. 1. The net result is that shutdown can have the same high power requirements and require the same type of planning as startup.

The power supply's primary duty is to supply its rated voltage (generally +12V) and the level of current needed by the system. At startup or shutdown, devices such as hard disks drives may draw a considerable amount of current. For example, because of their design, hard disk drive motors can require double their steady-state current when they are spinning up from rest. If there are many hard disks in a system and several or all of them start up at the same time, there can be a tremendous demand on the power supply's ability to provide its rated voltage. Fortunately, most power supply companies consider this and build into the power supply the ability to exceed its normal output for a short period, such as during startup. This is usually specified by the manufacturer as a “peak” rating. Despite this extra capacity, it is still possible to exceed the power's supply's stated power capacity, such as when new equipment is added to the system or existing equipment is replaced with equipment having different power characteristics.

Savvy IT and communications equipment managers plan for peaks when deploying power infrastructure through several methods. Typical practices in planning electrical infrastructure that accommodates peak load include performing a review of manufacture literature about average/peak power draws of equipment. However, it is often difficult to know the peak load of a particular device, such as a hard disk, up front, because manufacturers often only specify the steady-state power requirements of the device. An incorrect guess as to the peak power requirements of the device can lead to selection of an inadequate power supply. Planning practices may also include measuring power loads under various conditions to get empirical data about loads. Once these loads are established, and inventory of IT and communications equipment is completed, a summary peak load can be calculated, as well as average loads, and the electrical power infrastructure can be designed accordingly. Following this planning, the managers simply select a power supply with a size and load capabilities that exceed the expected load of the system by a safe margin. Selecting an inadequate power supply can result in tripped breakers or dips in voltage of the power supply, leading to a failed startup sequence, equipment that is non-operational, a failed shutdown sequence, hard drive/disk/data corruption, failed application shutdown, failed termination of services, and so on. Unfortunately, larger power supplies cost more money and add weight that may be undesirable in some environments, such as mobile computing environments.

Another practice in the IT industry is the serialization of equipment startup based on a fixed delay, which spreads the startup peak power draw over time. For example, managers can purchase power strips or towers that, at startup, apply power to each outlet of the power strip in succession after a fixed delay (e.g., 10 seconds). This solution reduces the power requirements of the system by spreading out the peak power draw of each device, but also increases the startup time of the system and requires careful coordination by the manager to ensure that each piece of equipment is started in an acceptable order. For example, fans may need to be started to cool the system before disk drives or processors are started that generate heat. In addition, this solution is not applicable to system shutdown. The manager must separately serialize the shutdown of multiple servers, networking equipment, and communication equipment in order to achieve similar low peak power requirements during the shutdown sequence. Because of these dynamics, IT and communications equipment managers routinely create manual shutdown sequence procedures for equipment. In the event that the systems need to be shut down, these procedures must be carried out carefully, by trained technicians. In environments where a shutdown must be performed in a hurry, or performed by untrained technicians (or worse, when no technicians are available at all) it is typical that the shutdown sequence is not performed correctly or timely, resulting in lost data or other negative results.

Deploying IT and communications equipment in temporary, harsh, or mobile environments poses unique problems for power, startup, and shutdown management. These challenges include: requirements to reduce the weight, size, and cost of electrical power generation equipment to enable fast/easy transport, reduce operational costs, and improve system reliability; requirements to reduce the weight, size, and cost of battery-backup systems that operate equipment during a power failure to enable fast/easy transport, reduce operational costs, and improve system reliability; and requirements to perform reliable shutdowns quickly, routinely, and with no errors. Due to the poor reliability of power sources in these environments, the frequent setup/tear down of systems to enable redeployments, and the setup/tear down of systems by untrained technicians, the shutdown protocol must work reliably.

Today's solutions do not address these problems reliably or accurately and miss significant opportunities to reduce weight and cost of systems. Furthermore, manual shut down procedures are error prone and slow, resulting in frequent abnormal termination of services, data loss, and reservation/usage of unused services, often requiring substantial technical troubleshooting to return the equipment to working order.

### BRIEF DESCRIPTION OF THE DRAWINGS

FIG. 1 illustrates the power spike typical in IT systems during startup.

FIG. 2 illustrates fan voltage requirements based on fan speed.

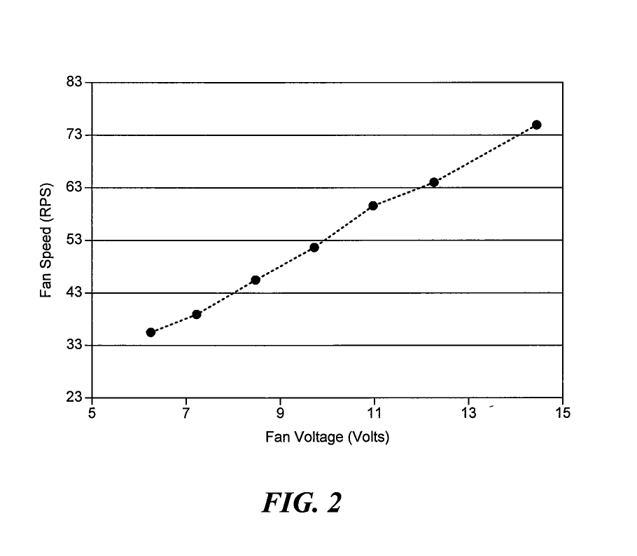

FIG. 3 is a block diagram that illustrates components of an intelligent power control system, in accordance with one embodiment of the present invention.

FIG. 4 is a flow diagram that illustrates the process used by the system of FIG. 3 to find a preferred powering sequence.

FIG. 5 is a graph that illustrates a resulting power profile produced by the system of FIG. 3.

### DETAILED DESCRIPTION

### Overview

An intelligent power control system for intelligently controlling startup and shutdown sequences of IT equipment to reduce peak power requirements is provided. The intelligent power control system sends an indication to power up to a power module connected to an electronic device. For example, the electronic device may be a computer system connected to a remotely addressable power module. The intelligent power control system monitors the power consumption of the electronic device during startup, and determines when the electronic device has reached a peak level of power consumption. For example, the device may go through an initial period during startup where more power is consumed to spin up disk drives or fans. The intelligent power control system then powers up other devices based on the power consumption characteristics of each preceding device. For example, the system may wait until each device has passed its peak level of power consumption to power up the next device. The intelligent power control system may use similar techniques when shutting down devices or transitioning devices from a low-power state to a normal power state. Thus, the intelligent power control system establishes an order and timing for powering up or down electronic devices that improves the power consumption characteristics of the electronic devices. For example, the system may reduce the peak load of the devices during startup while keeping the overall start time of the devices low. In this way, the system reduces the power requirements of the electronic devices allowing smaller, lighter, and less expensive power supplies and battery backup systems to be used.

### Suitable System

In some embodiments, the intelligent power control system includes software (e.g., firmware) that is able to intelligently startup and shutdown heterogeneous networks of IT or communications equipment. The software may sequence the startup and shutdown of equipment through networking commands over any number of protocols (TelNet, SSL, XML, SNMP), as well as controlling and monitoring the input power to the devices. The software can be loaded on standard application servers, can be embedded in electronic equipment, or can be executed as a module from other software packages, such as commercial network management systems including HP Open View, IBM Tivoli, and so forth.

In some embodiments including deployable/mobile environments, the intelligent power control system works in conjunction with power-control electronics loaded on-board ruggedized transit cases that include many types of electronic devices (e.g., the PacStar IQ-Core Case, described further below). In these environments, the software may be on-board an application server included in the transit case. The software can be incorporated into an easy-to-use network management software package (e.g., the PacStar IQ-Core Software).

The PacStar IQ-Core Case is a modularized and ruggedized rack structure that consists of a fan cooled and air filtered housing with pull out trays. These trays offer a custom slide rail structure, common monitoring and power and network cable interconnects at the rear and universal network connections at the front. The case housing and tray structure are designed to meet MIL STD 810F requirements for transportation, vibration, shock, and temperature. The case extends the life of electronic devices, reduces maintenance requirements, and lowers network management complexity. The case is intelligent and includes embedded microcontrollers that monitor internal temperatures, allow remote presence (AC power control, console port access), provide visual and auditory alerts, and provide an easy-to-use menu system for common operations.

Each case holds basic knowledge of the contained IT or communications devices, and allows viewing of this information via the built-in menu system on the top tray. This includes information like make, model, serial number, IP addresses, MAC addresses, etc. Additionally, the case itself is an IP device and will display its operating parameters and internal temperature values on the built-in display. The case has a resident web page which can be accessed via any browser.

The intelligent power control system may use two features of the IQ-Core Case in particular: the ability to remotely control and monitor the AC power on any device in the case, and the ability to remotely access the console port on any device (e.g., through a serial-IP converter). Thus, non-responsive devices can be dealt with remotely and even simple non-IP devices can be supported.

The PacStar IQ-Core Software works in conjunction with the IQ-Core Case and all devices contained within it to provide health monitoring, configuration, backups, alerting, and more. It not only provides an easy-to-use Windows application interface, but also can modify the menu system of an IQ-Core Case with application-specific functionality. Unlike standard network management software packages, IQ-Core technology is designed explicitly for rapid deployment, adaptable under changing conditions, and usable by less-skilled personnel. IQ-Core software operates at a higher application level and concentrates on those features that are most useful for deployable networks.

The intelligent power control system may integrate with the IQ-Core Software. The user can use this system to startup, shutdown, and monitor the power-draw of each of the devices contained within the IQ-Core Case, as well as monitoring the total power draw.

In some embodiments, the intelligent power control system uses an intelligent controller within a UPS device (e.g., in an IQ-Core case tray) to determine when the system is running on backup battery power. The system may power off certain non-essential devices when the system is running on battery power to increase the usable time of the system before the battery is drained. This extra time may allow support personnel to restore the main power source before the battery is drained to avoid interruption to essential services provided by the system.

### System Components

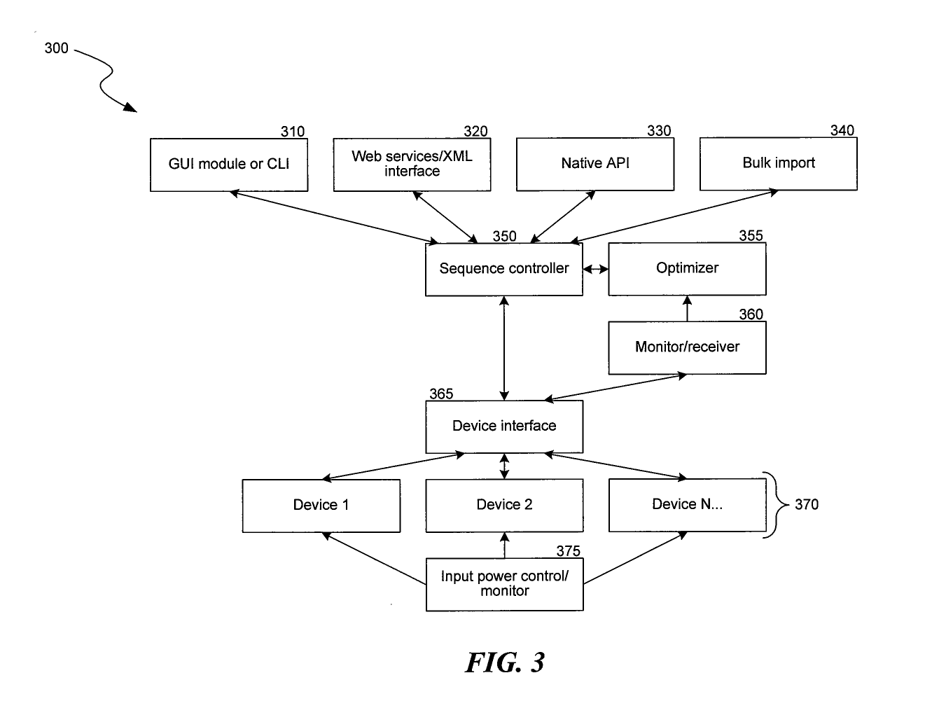

FIG. 3 is a block diagram that illustrates components of the intelligent power control system, in one embodiment. The system 300 includes a graphical user interface (GUI)/command-line interface (CLI) module 310, a web services/XML interface 320, a native API 330, a bulk import component 340, a sequence controller 350, an optimizer 355, a monitor/receiver component 360, a device interface 365, one or more devices 370, and an input power controller and monitor 375. The GUI/CLI module 310 provides an interface to users, such as administrators, for using the system, such as by allowing users of the system to input data, commands, and parameters to control the system. The GUI/CLI module 310 further allows the users to view results of startup and shutdown test runs and actual runs, which may be presented via tabular reports or graphs. The results of test and actual runs, as well as the input parameters and data, may be input/read by the optimizer 355 to generate improved startup/shutdown sequences. The GUI is only one method of controlling the system, and is an optional component. It may be implemented using any number of user interface solutions, such as Windows, Mac, HTML, or other standard interfaces. The GUI/CLI module 310 may also provide a command line interface familiar to administrators of systems such as Linux, DOS, or Cisco IOS. The GUI/CLI module 310 may present results from test runs or normal runs, and may present the power-draw graphs (power draw over time) for each device. The GUI/CLI module 310 may also allow users to manually set the startup sequence via fixed times, dependencies, or relative start times, such as by manually entering timing information or by dragging the individual graphs with the mouse to set start times.

The web services/XML interface 320 provides a data/programmatic interface in a web services/XML format, allowing other applications to use the system to input data, commands, and parameters to control the system. The web services/XML interface 320 further allows applications to access results of startup and shutdown test or normal runs, which may be presented via tabular reports or graphs. The web services/XML interface 320 interface is only one method of controlling the system, and is an optional component that may be used in conjunction with, or separate from the other interfaces.

The native application programming interface (API) 330 provides data/programmatic interfaces in native .NET, C, C++, RPC or other formats, allowing other applications to use the system 300 to input data, commands, and parameters to control the system. The native API 330 further allows the applications access to results of startup and shutdown test runs and actual runs, which may be presented via tabular reports or graphs. The native API 330 is only one method of controlling the system 300, and is an optional component that may be used in conjunction with, or separate from the other interfaces.

The bulk import component 340 provides data/programmatic interfaces in other file/data formats, allowing other applications to use the system 300 to input data, commands, and parameters to control the system 300. The bulk import component 340 further allows the applications access to results of startup and shutdown test runs and actual runs, which may also be presented to a user via tabular reports or graphs. Using the bulk import component 340, the system 300 may import data in formats such as comma/tab delimited ASCII, or other formats such as MS Excel or MS Project. Another typical source of bulk data are Network Management Systems, such as HP OpenView.

The sequence controller 350 is responsible for issuing the startup or shutdown commands to the network devices and AC power control units (through the device interfaces as appropriate), based on the parameters and input data provided through any of the interfaces to the system 300. The sequence controller 350 may read a list of devices, timing and dependency information, and optional “soft” commands, and execute those commands by sending them to the devices. The sequence controller 350 may have several modes, such as a test mode, normal mode, and real-time mode. In test mode, the sequence controller 350 runs the sequence in series in order to generate a baseline power-draw profile for each device. In normal mode, the sequence controller 350 runs the sequence and follows the timing information as specified by the sequence (e.g., as supplied manually or generated by the optimizer 355). In real-time mode, the sequence controller 350 runs the sequence using measurements of the actual total power-draw and estimates or measures of each device's power draw, to start (or shutdown) each device as soon as possible, within a maximum power limit or threshold.

The optimizer 355 is responsible for analyzing the power load reports generated after each “run” of the sequence controller 350, and generates improved timing sequences for starting/shutting down devices, based on the optimization parameters supplied through the input interfaces 310-340. The optimizer 355 can use any number of goal seeking/optimization/learning algorithms. At its most brute force (and because computational cycles are so inexpensive on modern microprocessors), the optimizer 355 can simply try up to all permutations of startup sequences or shutdown sequences, within the given parameters, to find the most improved sequence. Once the optimizer 355 has completed its work, it modifies the input parameters to the sequence controller 350. The optimizer 355 can be run after every startup/shutdown sequence, can be run manually, or can be run on designated test sequences.

The monitor/receiver component 360 collects the AC power characteristics or status (and other on/off related status) of the devices in the network, and creates the reports used by both the user (for manual review) and the optimizer 355 (for input into the optimization process). The monitor/receiver component 360 is capable of monitoring devices at a level of granularity specified by the user (for example, 1 second, or 500 millisecond intervals), and is also capable of receiving “pushed” data from devices, such as SYSLOG data. The monitor/receiver component 360 may poll devices that do not push data, and may poll the power-control module as well. The monitor/receiver component 360 also monitors the power-draw of devices, so that it can tell if/when a device is completely shut down, as indicated by a zero power draw. The monitor/receiver component 360 may also use other means to determine if a device is running, such as performing network PINGs or checking operating system information (e.g., to see if a software application's processes are running).

The device interface 365 is designed to work with heterogeneous devices 370. Because many devices have a wide variety of interfaces, the system 300 includes a device abstraction layer to insulate the monitor/receiver component 360 and the sequence controller 350 from the different communications protocols of the devices 370. The device interface 365 presents a standard set of functions to the “business logic layers” above it, and translates commands and data formats to the device-specific formats to control the devices 370. The device interface 365 may communicate with devices and software packages in a wide variety of protocols, including by not limited to SNMP, TelNet, FTP, CLI, Web Services, SOAP, XML, WMI, RPC, SMPT, SSH, HTTP and more. The devices 370 may be any kind of IT or communications equipment or software application, such as switches, routers, servers, firewalls, wireless access points, satellite modems, radio gateways, analog phone adapters, RAID arrays, load balances, or data encryption devices. Software applications could include operating systems, software PBXs, NMS, SIMS, software encryption packages, VPNs, caching/proxy systems, IP accelerators, and any number/type of application software.

The input power controller and monitor 375 is responsible for turning on/off the input power to any device in the network, such as devices 370. The input power controller and monitor 375 is also responsible for monitoring the power draw for each device and reporting that information back to the monitor/receiver component 360. The input power controller and monitor 375 is able to control and monitor the power for each device individually.

The computing device on which the system 300 is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system 300 may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Startup Sequencing and Timing

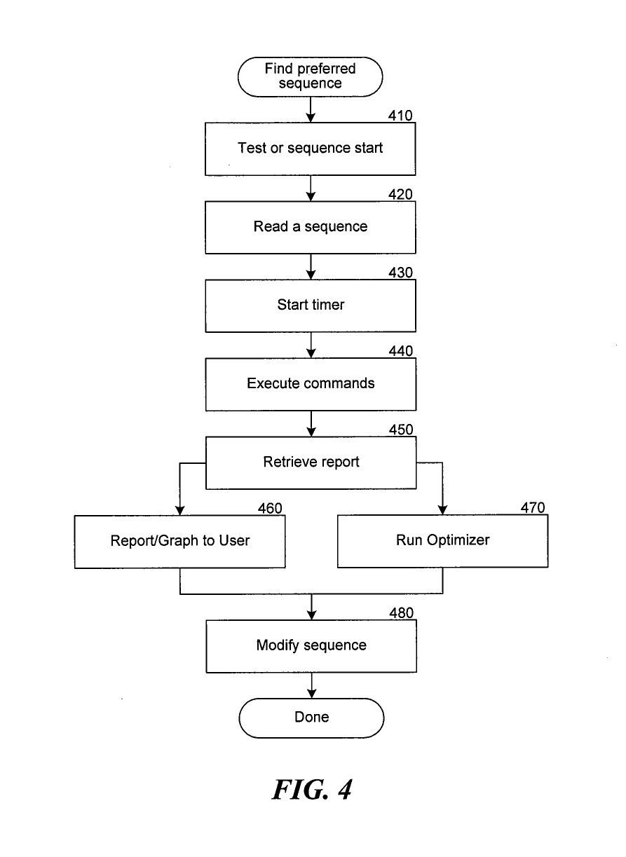

FIG. 4 is a flow diagram that illustrates the process used by the system of FIG. 3 to find a preferred powering sequence, in one embodiment. The system may perform this type of control flow any number of times until the user is satisfied with the results. This flow is used to create/improve a sequence and is typically performed during network or equipment development. The system can be configured so that after the startup/shutdown sequences are created and the network or equipment is deployed, then blocks 410 through 440 are normally the only steps executed for the proper startup/shutdown of the network or equipment. The system can also be configured so that the optimizer runs for all executions of the sequence, such that the sequence is continuously optimized.

In block 410, the system begins a startup or shutdown sequence. There are at least 4 type types of sequences (normal startup, normal shutdown, and test variants of startup and shutdown), and sequences may also be “named” specifically, so that multiple “named” sequences can be saved and run. This allows the system to control many different networks of sets of equipment from a single implementation, or allows different sequences of startup/shutdown of a single network that may be required depending upon network configuration changes. The start of a sequence may be initiated automatically through a trigger, such as a timer or the network losing AC power, or may be initiated manually. The test variants of the sequences typically startup or shutdown devices strictly in sequence, in order to generate a baseline power-draw profile for each device. From a test sequence run, the IT administrator or optimizer can begin creating an optimized sequence.

In block 420, the system reads the sequence input information, the input parameters and device input information. The sequence information can be read from disk, memory, or retrieved through the program API modules, as specified by the user. If the system runs a test sequence, the devices will be powered up or shutdown in series. A test sequence's goal is to identify a baseline of power-curves for the devices, so the commands are essentially run “one at a time.”

In block 430, the system starts up a timing process that is used to control when devices are started or shut down. In block 440, the system receives the timer events and executes the commands in the chosen sequence. This causes the startup or shutdown of the devices, which in turn may cause event/log information to be generated and stored by the monitor/receiver. One key mode (real-time mode) of the system allows the execution of the commands to be performed based on real-time monitoring of the then current power draw plus the estimated or measured peak-power draw of the next-in-line device to be started/shutdown, without following a fixed or specified starting-time sequence. That is, users may manually determine the steady-state power requirements of a device, and the peak power draw of the device, and instruct the system simply to start (or shut down) each device in sequence, such that at no time the current power draw in addition to the estimated/measured peak power draw of the next device to be started (or shutdown) exceeds a maximum threshold.

In block 450, the system uses the timer events, and executes the commands in the sequence. In turn, this will cause the monitor/receiver to monitor and log the power draw and other status information for each of the devices controlled in the sequence, in the form of a report. This report data can be thought of as a graph of power draw and events, over time, for each device. This report is retrieved at the end of the sequence, and provided to the optimizer module and/or the various interfaces (such as the GUI).

In block 460, the GUI (or other interfaces to the system), can display the results of the report to the user in a tabular data format or a graphical representation. The report shows each device, its power draw, other event information (such as the shutdown time, the length of time required to shutdown, etc). The GUI may provide individual graphs for each device on a single screen, and may allow users to draw/drop or visually “slide” the device's graph to a specific start/stop time, enabling a graphic means for users to input sequence information, which is then used to edit the underlying sequence.

In block 470, the system runs the optimizer against the report retrieved in block 450. The optimizer uses the input parameters specified to create improved or preferred sequence start times for the devices, based on the optimization targets. One goal may be to minimize the total peak power draw of the combined devices, while minimizing the total sequence time. The optimizer computes the peak power draw for each combination of starting times, while keeping the start time in the allowable maximum startup/shutdown time. The optimizer slides the startup time by a specified sampling rate. The optimizer compares the resulting sequences for the lowest peak power draw and lowest sequence time, and selects the best results.

The optimizer may use a variety of algorithms to reduce the computational time required to perform this task, such as halting computation time once an acceptable solution is found that falls within the input parameter targets. These approaches may include:

| | |
|---|---|
| Simple Sequencing | Using an order of devices (such as by |
| | numeric device identifiers assigned by the |
| | system) or precedence information supplied |
| | in the input, the optimizer may compute the |
| | maximum power load incurred by |
| | computing a starting time for each device |
| | such that no device is started prior to the |
| | prior device finishing its peak draw, as |
| | measured in its graph. |
| Brute Force/Comprehensive | Using any device order (taking manual |
| Optimization | precedence into account) the optimizer may |
| | compute the total peak load for any |
| | available start sequence. This approach is |
| | computationally expensive, but can find |
| | better solutions. |
| Heuristic-Driven | The optimizer may use rules such as “first |
| Optimization | start the devices with the largest power- |
| | draw peaks” - so that the peak power draw |
| | is incurred on top of the lowest underlying |
| | steady-state draw. |
| Statistically/Al-Driven | Using goal-seeking, Bayesian, or neural net |
| Optimization | solutions, or other multi-dimensional |
| | problem solving techniques, the optimizer |
| | may be able to find good solutions using |
| | computationally efficient approaches. |

The optimizer may take advantage of accelerated computing capabilities, such as SIMD (Single Instruction Multiple Data) instructions available on many modern microprocessors. The optimizer may use sequence information such as manual start times as predecessors to avoid computing start times that would fall outside of those parameters.

In block 480, if the user (through the GUI or other interface) makes changes to the sequence, or the optimizer specifies a revised sequence, the system will make the changes and save the changes.

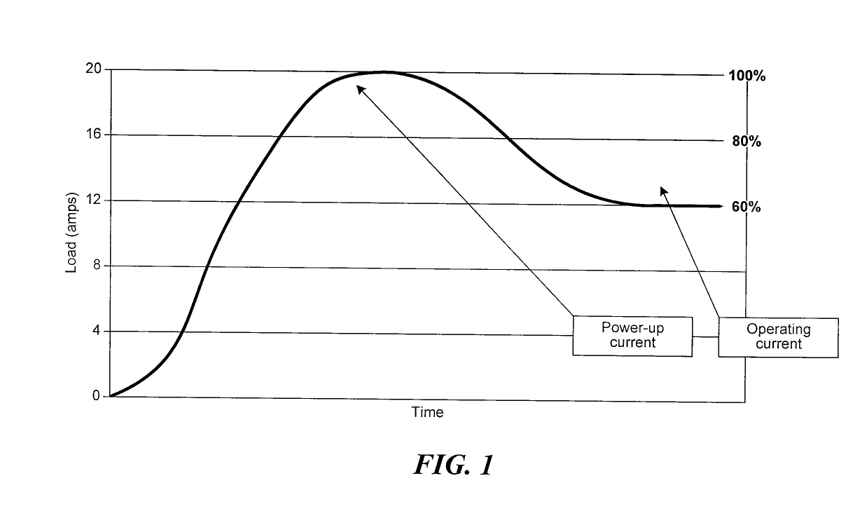

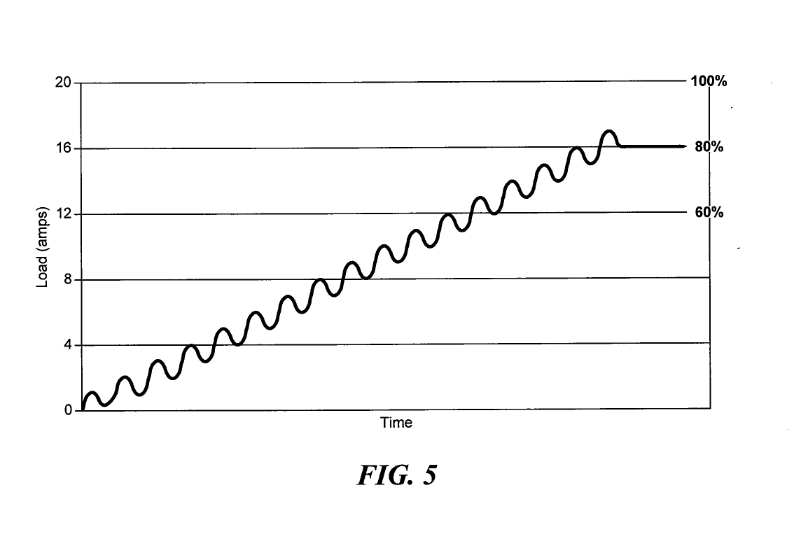

FIG. 5 is a graph that illustrates a resulting power profile produced by the system of FIG. 3, in one embodiment. Compared to FIG. 1, FIG. 5 illustrates the lower peak power requirements of the intelligent power control system. In some embodiments, the system may overlap the startup of devices creating an even smoother curve than the one shown. For example, as one device begins to drop from its peak power usage another device may be started such that it is approaching its peak power usage. Thus, the cumulative power consumed by the two devices may remain closer to a steady peak amount rather than the rise and fall in FIG. 5.

From the foregoing, it will be appreciated that specific embodiments of the intelligent power control system have been described herein for purposes of illustration, but that various modifications may be made without deviating from the spirit and scope of the invention. Accordingly, the invention is not limited except as by the appended claims.

I/We claim:

1. A method of controlling the timing and sequence of powering up multiple electronic devices to control a peak level of power consumed by the devices, the method comprising:
sending to a first power module connected to a first electronic device an indication to power up the first electronic device;
determining when the first electronic device has reached a target level of power consumption;
at a time based on determining when the first electronic device has reached the target level of power consumption, sending to a second power module connected to a second electronic device an indication to power up the second electronic device.

2. The method of claim 1 wherein the target level of power consumption is the steady state power level of the first electronic device.

3. The method of claim 1 wherein the target level of power consumption is selected to keep the peak level of power consumption below a threshold.

4. The method of claim 1 wherein the first electronic device consumes more power for a limited amount of time during startup than during normal operation.

5. The method of claim 1 wherein the time for starting the second electronic device is selected to reduce the overall peak power draw of powering up the multiple electronic devices.

6. The method of claim 1 further comprising storing the order and timing of sending the indication to each device as a powering sequence to be used during future powering up of the multiple devices.

7. A computer-based system for determining a powering sequence for multiple devices, the system comprising:
an input component configured to receive a selection of the multiple devices to be powered in the powering sequence;
a sequence controller component configured to send commands to the selected multiple devices based on the powering sequence;
an optimizer component configured to determine an order and a timing for powering the selected multiple devices; and
a device interface component configured to indicate to the selected multiple devices when to apply or remove power based on the determined order and timing.

8. The system of claim 7 wherein the powering sequence is a startup sequence for starting up the selected multiple devices.

9. The system of claim 7 wherein the powering sequence is a shutdown sequence for shutting down the selected multiple devices.

10. The system of claim 7 wherein the optimizer determines an order and a timing that minimizes the peak startup current while reducing the system startup time.

11. The system of claim 7 further comprising a power consumption monitoring component configured to monitor the power consumed by a device.

12. The system of claim 11 wherein determining the timing for powering the selected multiple devices includes using the power consumption monitoring component to determine a period of peak power consumption during the startup of the device.

13. The system of claim 7 wherein the sequence controller determines when the selected multiple devices are running on a backup power supply and the powering sequence powers down a subset of the selected multiple devices.

14. The system of claim 7 wherein the device interface component provides a common interface to the other components of the system that it translates to one or more device-specific protocols for communicating with the selected multiple devices.

15. The system of claim 7 wherein the optimizer component employs a simple sequencing strategy to determine the order and timing.

16. The system of claim 7 wherein the optimizer component employs a brute-force optimization strategy to determine the order and timing.

17. The system of claim 7 wherein the optimizer component employs a heuristic-driven strategy to determine the order and timing.

18. The system of claim 7 wherein the optimizer component employs a stastically-driven strategy to determine the order and timing.

19. A computer-readable storage medium for determining a preferred sequence and timing for powering multiple electronic devices, by a method comprising:
performing a first sequence of powering operations that applies or interrupts power to each of the multiple electronic devices while monitoring the power consumption characteristics of each of the multiple devices;
determining a second sequence based on the first sequence for improving the power consumption characteristics of the multiple electronic devices;
performing the second sequence of powering operations while monitoring the power consumption characteristics of each of the multiple devices; and
selecting as the preferred sequence between the first sequence and the second sequence the sequence having better power consumption characteristics.

20. The computer-readable medium of claim 16 wherein the preferred sequence is the sequence having the lowest startup time.

21. The computer-readable medium of claim 16 wherein the preferred sequence is the sequence having the lowest peak power consumption.

22. The computer-readable medium of claim 16 wherein the steps of the method are performed repeatedly until no further improvement is made to the power consumption of the multiple electronic devices.

23. The computer-readable medium of claim 16 wherein the method further comprises entering a test mode that comprises starting each device in the first sequence in series in order to generate a baseline power-draw profile for each device.
